(19) United States
(12) Patent Application Publication
(10) Pub. No.: US 2007/0068712 A1
(43) Pub. Date: Mar. 29, 2007

(54) Hybrid Electric Vehicle

(76) Inventor: Eric Scott Carnahan, Smyrna, GA (US)

Correspondence Address: Eric Scott Carnahan, 2615 Carolyn Dr, Smyrna, GA, 30080, US

(21) Appl. No.: 11/162,792

(22) Filed: Sep. 23, 2005

(51) Int. Cl. B60K 1/00

(52) U.S. Cl. 180/65.2

(57) ABSTRACT

A hybrid electric vehicle having an internal combustion engine as its primary power source and a turbine engine that is powered by waste heat from the internal combustion engine as an additional power source.

### TECHNICAL FIELD

The present invention relates generally to hybrid electric vehicles and to external heat engines, which can convert thermal energy contained within a hot gas into mechanical energy.

### BACKGROUND OF THE INVENTION

It is well known to construct a hybrid electric vehicle (hereinafter abbreviated HEV) that utilizes an internal combustion engine (hereinafter abbreviated ICE), an electric generator and an electric motor. HEVs have been built in a huge variety of different configurations.

In some HEVs an ICE drives a generator that generates electricity, which powers an electric motor that drives the wheels. In other HEVs (sometimes called mild HEVs) the ICE and the electric motor are configured such that both the engine and motor can be used to drive the wheels at the same time.

HEVs are usually more efficient than vehicles that are powered only by ICEs because ICEs are typically not very efficient over a broad range of operating conditions. They also have advantages over purely battery powered electric vehicles because such vehicles can typically only cover a small distance before their batteries need to be recharged.

It is also known outside of the automotive industry to convert thermal energy from a relatively low temperature heat source, such as the exhaust gas from an ICE, into mechanical energy by utilizing an external heat engine that cycles a working fluid through a suitable thermodynamic process. Many different types of heat engines have been used for this purpose. A Stirling engine is an example of an external heat engine that can convert thermal energy from almost any heat source into mechanical energy.

Thus it is possible to create a vehicle that uses an ICE as its primary power source and has a second heat engine powered by waste heat from the ICE as an additional power source. Such a vehicle could be more efficient than a vehicle that uses only an ICE. However such a vehicle would also has some disadvantages. For example, integrating the power output from two engines into a single drive train could greatly increase the complexity of the vehicle. However this additional complexity could be minimized in an HEV because power could be transferred electronically rather then mechanically from the second engine to the vehicle's drive train.

Even with a simplified means of integrating the power output of two engines, this new type of vehicle would also have the disadvantage of the additional weight and cost of the second engine. Stirling engines typically have low power to weight ratios and are expensive to build. Thus such a vehicle utilizing a Stirling engine as an additional power source would not likely succeed in the marketplace. However if such a vehicle could utilize a compact engine with a high power to weight ratio that is inexpensive to build, it would have a good chance of being commercially successful in the marketplace.

### BRIEF SUMMARY OF THE INVENTION

Briefly described, in a preferred embodiment, the present invention overcomes the above-mentioned disadvantages and meets the recognized need for an efficient vehicle by providing a HEV capable of higher thermal efficiencies than existing HEVs and vehicles that are powered only by ICEs. The invention will be capable of higher efficiencies because thermal energy from the exhaust gas of the ICE, which is typically wasted, will be utilized to generate electricity to power the vehicle's electric motor.

The present invention includes a special type of turbine engine that utilizes the exhaust gas from the vehicle's internal combustion engine as both the working fluid and power source of the turbine. The turbine creates power by expanding the exhaust gas from the ICE adiabatically through an expansion turbine from the pressure at which the exhaust gas leaves the engine to a sub-atmospheric pressure. The expanded exhaust gas is then passed through a heat exchanger where it is cooled. The cooled exhaust gas is then compressed back to ambient pressure by a compressor and expelled from the turbine. Because the exhaust gas has been cooled before it entered the compressor it is at a denser state than it was after it left the turbine, and because it is denser, the compression process requires less work than the amount of work that is produced by the expansion process. Thus, the turbine engine produces a net work output. The turbine engine can be constructed with one or more cooling and compression stages. Having more than one cooling and compression stage can increase the efficiency of the turbine because the average temperature of the gas during the compression process will be reduced which will increase the density of the gas and reduce the amount of work required to compress it.

The mechanical energy produced by the turbine engine is then used to power an electric generator that provides electric energy to the vehicle's electric motor.

It is a further goal of a preferred embodiment of the invention to more efficiently harness the thermal energy created inside the ICE by minimizing or eliminating the unrestrained expansion of exhaust gasses exiting the engine cylinders. Typically when the exhaust valve of an ICE opens, the gas within the cylinder is still at a pressure that is above atmospheric pressure. Thus the gas within the cylinder expands in an unrestrained fashion until the pressure within the cylinder has reached the pressure of the gas within the exhaust manifold. This unrestrained expansion is inefficient because no work is harnessed by the engine from the gas during the unrestrained expansion process.

The expansion turbine of a preferred embodiment of this invention creates a resistance to the flow of exhaust gases leaving the engine cylinders such that the pressure of the gas within the exhaust manifold is roughly equal to the pressure of the gas within the cylinder when the exhaust valve opens. The exhaust gas will then expand adiabatically within the turbine engine where the work from the expansion process can be converted to mechanical energy.

This arrangement will decrease the power output from the ICE because the engine must do more work to expel the exhaust gas from the engine. However it will increase the power output of the expansion turbine by a larger amount and thus increase the total power output of the combined engines for a given amount of fuel consumed.

### BRIEF DESCRIPTION OF THE DRAWINGS

The present invention will be better understood by reading the Detailed Description of a Preferred and an Alternate Embodiment with reference to the accompanying drawing figures, in which like reference numerals denote similar structure and refer to like elements throughout, and in which:

FIG. 1 is a schematic illustration of the present hybrid electric vehicle having a single cooling and compression stage;

FIG. 2 is a schematic illustration of the present hybrid electric vehicle having two cooling and compression stages;

FIG. 3 is a pressure/volume diagram of working gas cycled through an air-standard Otto cycle;

FIG. 4 is a pressure/volume diagram of working gas cycled through an air-standard Otto cycle engine and then through the single cooling stage turbine engine of the present invention illustrated in FIG. 1;

FIG. 5 is a pressure/volume diagram of working gas cycled through an air-standard Otto cycle engine and then through the dual cooling stage turbine engine of the present invention illustrated in FIG. 2;

### DETAILED DESCRIPTION OF A DRAWING OF A PREFERRED AND AN ALTERNATE EMBODIMENT

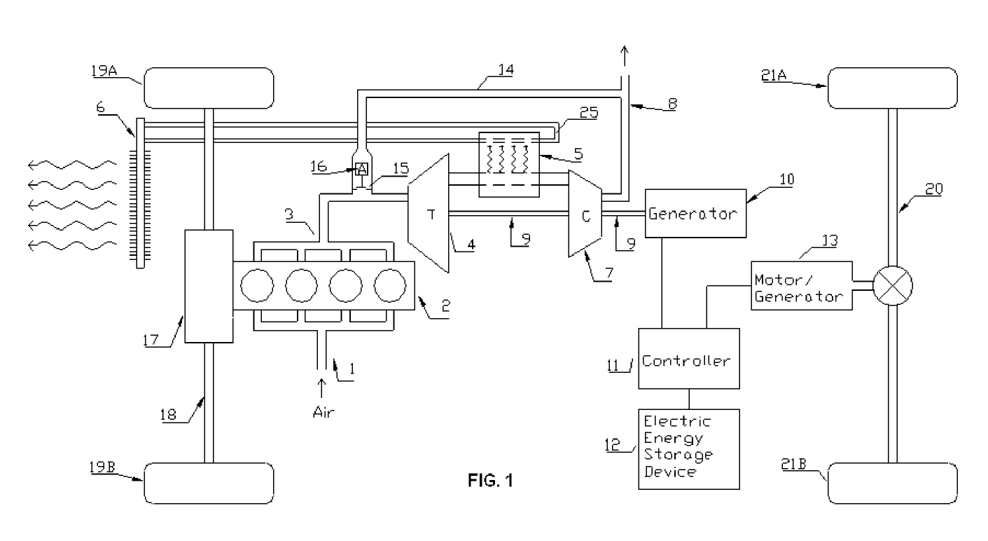

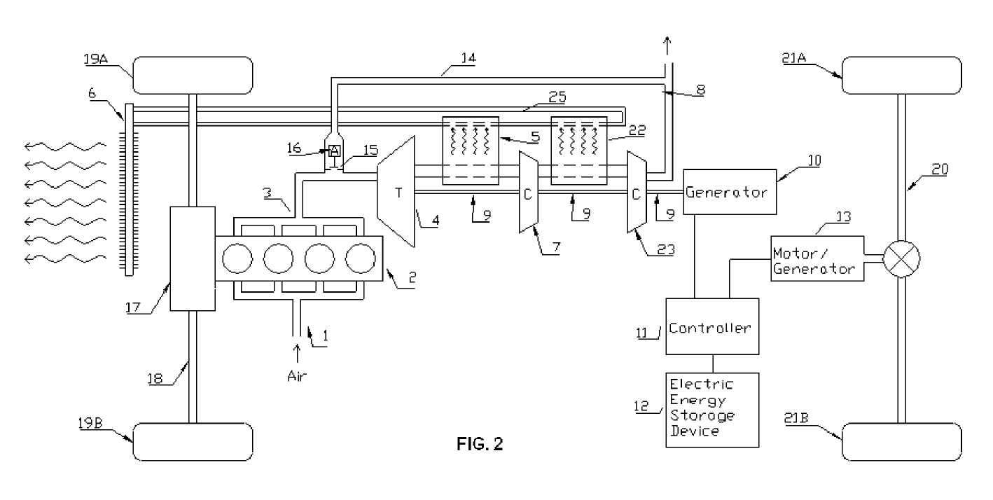

In describing the preferred embodiment and an alternate embodiment of the present invention, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, air enters the intake manifold 1 of the internal combustion engine 2. A transmission 17 transfers power from engine 2 to front axel 18. Front axle 18 transfers power from transmission 17 to the front wheels 19A and 19B. The exhaust gas exits engine 2 through the exhaust manifold 3 and enters the expansion turbine 4 where it expands adiabatically to a sub atmospheric pressure. Upon exiting expansion turbine 4, the exhaust gas enters a heat exchanger 5 where it is cooled. A cooling fluid 25 is preferably circulated continuously through the heat exchanger 5 and then through a radiator 6 where heat is rejected to the atmosphere. Radiator 6 could be a radiator that is used by internal combustion engine 2 or it could be a separate radiator. Additionally heat exchanger 5 could reject heat directly to the atmosphere by through the its external surface. Preferably, cooling fins would also be added to the external surface of the heat exchanger to increase the amount of heat transferred through the surface to the atmosphere.

The cooled exhaust gasses from heat exchanger 5 enter a compressor 7 where they are compressed back to atmospheric pressure and are expelled to the atmosphere preferably through the exhaust pipe 8. A rotating shaft 9 transfers power produced by the turbine to both the compressor 7 and an electrical generator 10. Electric generator 10 could also be operated as an electric motor to start or speed up the turbine engine if desired.

Electric power generated by generator 10 is sent to an electronic controller 11. The controller 11 sends the electric current it receives from generator 5 to either the electric energy storage device 12 (i.e. a battery, a series of batteries or a capacitor) or to the electric motors 13A and 13B depending on the operating conditions. Electric motors 13A and 13B drive the rear axels 20A and 20B, which drives the rear wheels 21A and 21B. Electric motors 13A and 13B can also be operated as electric generators enabling the vehicle to have regenerative braking.

Preferably an additional exhaust gas passageway 14 is provided to allow the exhaust gas exiting the internal combustion engine 2 to bypass the turbine if the engine is producing more exhaust gas than the turbine can handle. A valve actuation means 16 opens the valve 15 if the pressure in the exhaust manifold 3 exceeds a maximum desired pressure. For example, the second exhaust gas passageway could be used when the vehicle is accelerating to minimize the pressure within the exhaust manifold and maximize the power output of the internal combustion engine. The electric energy storage device 12 could be used at that time to provide additional electrical power to electric motors 13A and 13B to maximize the combined power output of internal combustion engine 2 and electric motors 13A and 13B.

Referring now to FIG. 2, the hybrid electric vehicle illustrated therein is identical to the vehicle illustrated in FIG. 1 with a few minor exceptions. The turbine engine of the vehicle illustrated in FIG. 2 has an additional heat exchanger 22 and an additional compressor 23. The first compressor 7 is also smaller than the compressor in FIG. 1 because it only compresses the exhaust gas by half as much. The size of the radiator 6 has also been increased so that it can handle the additional heat transferred to the cooling fluid in the second heat exchanger 22.

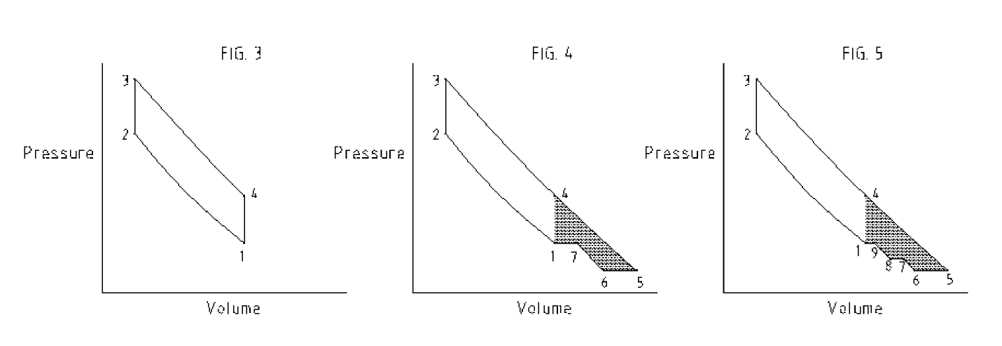

FIG. 3 is a pressure/volume diagram of an air-standard Otto cycle. It roughly models the operating characteristics of a working gas (air) cycled through a typical spark-ignition internal combustion engine commonly used by HEVs. Process 1-2 is an adiabatic compression of the gas within the cylinder as the piston moves from the bottom to the top of the cylinder. Process 2-3 is a constant-volume heat transfer to the gas from an external source representing the combustion of the fuel-air mixture. Process 3-4 is an adiabatic expansion of the gas as the piston moves from the top of the cylinder to the bottom. Process 4-1 is a constant volume heat transfer from the gas within the cylinder to an external source representing the process whereby the exhaust gas is expelled to the atmosphere and cooling by the surrounding air. Note that the gas does expand as it leaves the cylinder and contracts as it is cooled within the atmosphere, however this process takes place outside of the engine and does not affect the work output of the cycle. Thus it is excluded from the diagram. The enclosed area of the diagram can be interpreted as the net work output of one cycle of the engine.

FIG. 4 is a pressure/volume diagram of an air-standard Otto cycle combined with the turbine engine of the present invention illustrated in FIG. 1. It roughly models the operating characteristics of a working gas as it is cycled through a spark-ignition internal combustion engine and then through a single cooling stage turbine engine of the present invention. Process 1-2 is an adiabatic compression of the gas within the cylinder as the piston moves from the bottom to the top of the cylinder. Process 2-3 is a constant-volume heat transfer to the gas from an external source representing the combustion of the fuel-air mixture. Process 3-4 is an adiabatic expansion of the gas as the piston moves from the top of the cylinder to the bottom. Process 4-5 is an adiabatic expansion of the gas as it moves through the expansion turbine of the turbine engine. Process 5-6 is a constant pressure heat transfer from the gas to an external source as the gas moves through the heat exchanger of the turbine engine. Process 6-7 is an adiabatic compression of the gas as it moves through the compressor of the turbine engine. Process 7-1 is a constant pressure heat transfer from the gas to the atmosphere after it has been expelled from the turbine engine. The enclosed area of the diagram can be interpreted as the net work output of one cycle of the combined Otto cycle and turbine engine. The shaded area within the enclosed area represents the additional work output produced by the turbine engine. This additional work is produced without consuming any additional fuel.

FIG. 5 is a pressure/volume diagram of an air-standard Otto cycle combined with the turbine engine of the present invention illustrated in FIG. 2. It roughly models the operating characteristics of a working gas as it is cycled through a spark-ignition internal combustion engine and then through a dual cooling stage turbine engine of the present invention. Process 1-2 is an adiabatic compression of the gas within the cylinder as the piston moves from the bottom to the top of the cylinder. Process 2-3 is a constant-volume heat transfer to the gas from an external source representing the combustion of the fuel-air mixture. Process 3-4 is an adiabatic expansion of the gas as the piston moves from the top of the cylinder to the bottom. Process 4-5 is an adiabatic expansion of the gas as it moves through the expansion turbine of the turbine engine. Process 5-6 is a constant pressure heat transfer from the gas to an external source as the gas moves through the first heat exchanger of the turbine engine. Process 6-7 is an adiabatic compression of the gas as it moves through the first compressor of the turbine engine. Process 7-8 is a constant pressure heat transfer from the gas to an external source as the gas moves through the second heat exchanger of the turbine engine. Process 8-9 is an adiabatic compression of the gas as it moves through the second compressor of the turbine engine. Process 9-1 is a constant pressure heat transfer from the gas after it has been expelled from the turbine engine into the atmosphere. The enclosed area of the diagram can be interpreted as the net work output of one cycle of the combined Otto cycle and turbine engine. The shaded area within the enclosed area represents the additional work output produced by the turbine engine. Note that the additional work produced by the dual cooling stage turbine engine is slightly larger than the work produced by the single cooling stage turbine engine.

Additional embodiments of the invention are also possible which can increase power output from the turbine engine and/or the ICE. For example a compression means can be provided to supply compressed air to the intake manifold of the ICE. The compression means could be powered from the turbine engine or directly from the ICE. This could increase the power output from both the turbine and the ICE. A standard turbocharger could also be added to the engine. In such an embodiment the expansion turbine of the present invention's turbine engine would be positioned downstream from the expansion turbine of the turbocharger.

In another embodiment the expansion turbine of the turbine engine could be constructed using two separate turbines. Wherein one expansion turbine has a shaft to transfer power to the generator and the other has a shaft to transfer power to the compressor of the turbine engine.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A hybrid electric vehicle comprising:
a) a vehicle body;
b) an internal combustion engine carried by said vehicle body having an exhaust system;
c) an electric generator;
d) an electric motor;
e) a means for transferring electric power generated by said electric generator to said electric motor;
f) at least one propulsion mechanism for moving said vehicle body;
g) a means for transferring mechanical power created by said electric motor to at least one of said propulsion mechanisms;
h) a turbine engine carried by said vehicle body capable of converting thermal energy contained within the exhaust gases being expelled from said internal combustion engine into mechanical energy comprising:
i. an expansion turbine in fluid communication with the exhaust system of said internal combustion engine wherein the exhaust gases leaving said engine are expanded to a sub-atmospheric pressure;
ii. a cooling means in fluid communication with said expansion turbine wherein the exhaust gasses leaving said turbine are cooled to a lower temperature;
iii. a compression means in fluid communication with said cooling means wherein the exhaust gasses leaving said cooling means are compressed from a sub-atmospheric pressure to a pressure approximately equal to atmospheric pressure and expelled from said compressor;
iv. a power transfer means for transferring power from said expansion turbine to said compression means;
v. a power transfer means for transferring power from said expansion turbine to said generator.

2. A hybrid electric vehicle according to claim 1 wherein at least one of said propulsion mechanisms is a wheel attached to the body of said vehicle.

3. A hybrid electric vehicle according to claim 1 having an additional exhaust gas passageway wherein exhaust gases leaving said internal combustion engine can bypass said turbine engine and a valve means to regulate the flow of exhaust gases through said additional exhaust gas passageway.

4. A hybrid electric vehicle according to claim 1 having a turbine engine according to claim 1 having at least one additional cooling means downstream from the first said compression means and having at least one additional compression means downstream from said additional cooling means.

5. A hybrid electric vehicle according to claim 1 wherein the electric generator driven by said turbine engine is also operable as a motor such that current can be supplied to the motor to start or speed up the turbine engine.

6. A hybrid electric vehicle according to claim 1 wherein the electric motor providing power to at least one of said propulsion mechanisms is also operable as a generator.

7. A hybrid electric vehicle according to claim 1 having a compression means for providing compressed air to the intake manifold of said internal compression engine.

8. A hybrid electric vehicle according to claim 7 having a power transfer means for transferring power produced from said turbine engine to said compression means.

9. A hybrid electric vehicle according to claim 1 having a power transfer means for transferring power from said internal combustion engine to at least one of said propulsion mechanisms.

10. A hybrid electric vehicle according to claim 1 having an additional electric generator powered by said internal combustion engine and a means for transferring electric power generated by said additional electric generator to said electric motor.
